(19) United States
(12) Patent Application Publication
(10) Pub. No.: US 2011/0191346 A1
(43) Pub. Date: Aug. 4, 2011

(54) DYNAMICALLY-CREATED PYRAMID TO DELIVER CONTENT

(75) Inventors: Jesse R. Vernon, Seattle, WA (US); Andrew B. Rothbart, Seattle, WA (US); Daniel J. Giambalvo, Seattle, WA (US); Daniel P. Cory, Seattle, WA (US); Karim T. Farouki, Seattle, WA (US)

(73) Assignee: MICROSOFT CORPORATION, Redmond, WA (US)

(21) Appl. No.: 12/697,942

(22) Filed: Feb. 1, 2010

(51) Int. Cl. G06F 15/16; G06F 17/30; G06K 9/54

(52) U.S. Cl. 707/741; 709/203; 707/769; 382/305; 707/E17.108; 707/E17.002; 707/E17.03

(57) ABSTRACT

Dynamically-created content may be rendered in the form of a virtual image pyramid, and tiles of the pyramid may be provided for display. In one example, a user interacts with a server-based application, and the application dynamically generates visual content to be shown to the user. Based on the application's interaction with the user, or based on some other type of state information, the application determines the appropriate magnification level at which to show content to the user, and also determines the particular spatial region of the content to show to the user. This content is rendered onto one or more tiles, and the one or more tiles are delivered to the user. In this way, tiles are created and may be rendered as if there were an image pyramid of the dynamically-created content.

### BACKGROUND

In many applications, images are delivered from a client to a server. For example, in various types of web applications (e.g., search, photo sharing, social networking, etc.), a user requests content through a web browser, and a server responds by delivering images. Sometimes these images involve large amounts of data, due to the number of images to be delivered, or due to the high resolution of a particular image. Delivering a large amount of image data consumes a large amount of bandwidth.

One way to manage the use of bandwidth and resources when delivering images is to use an image pyramid. In an image pyramid, visual content is rendered at various different resolutions, and is partitioned into tiles. For example, for a given set of images, a pyramid may be created that contains the images at various different magnification levels, with each level of the pyramid representing a different magnification level. Each magnification level may be divided into one or more tiles, where a tile is a spatial unit (e.g., a rectangle that is 1024×1024 pixels in dimension) that contains visual content. The number of tiles that are used to represent the content may depend on the magnification level. For example, when images are shown at a low magnification level, it is possible to fit a larger number of images onto a single tile. When images are shown at a high magnification level, a smaller number of images fit on a single tile (or a single image may be divided into many tiles).

Image pyramids are typically pre-calculated based on some sort of fixed content. For example, a pyramid could be pre-calculated based on a specific image or collection of images. However, this technique assumes that the images to be represented in the pyramid either do not change, or change only infrequently. For content that is created or organized dynamically, image pyramids typically are not used. For example, if a page of thumbnail images is to be shown to a user in response to an image search query, rendering the search results page typically involves sending each thumbnail image separately from the server to the client.

### SUMMARY

Image pyramids may be used to provide visual content, such as content that changes or that is dynamically created in response to user input. For example, a server may generate or retrieve some image content to be delivered to a user. Based on some type of state information (e.g., a prior interaction with the user, or some other source of state information), the server may determine that the content is to be delivered at a particular magnification level, and that a particular spatial region of the content (e.g., a 1024×1024 rectangle) is to be shown to the user. Based on this state information, the server may create a tile that contains the content to be shown. The tile that is created may be the tile that would exist if an image pyramid had been pre-calculated for the dynamically-created content. That tile may be delivered to a client and may be shown to the user.

In one example, a user interacts with a server-based application, and content is prepared for the user based on the interaction. One example of such server-based application is a search application that returns images in response to a user query. The user may submit a search query, and images that are responsive to the query may be dynamically generated or retrieved. Based on the magnification level at which the images are to be provided to the user, the images may be rendered onto tiles, and one or more of these tiles may be delivered to a client to be shown to the user. Creating appropriately-sized tiles helps to manage bandwidth, since a user's screen could be filled with a given number of tiles regardless of whether the tile contains a small portion of a highly-magnified image, or contains several de-magnified images. In this way, a high-resolution image can be shown to a user without using the bandwidth to transmit the entire high-resolution image at once, since it is possible to transmit just the tile(s) that represent the parts of the image that the user is requesting to see.

Various optimizations can be performed. For example, when visual content has been rendered at a particular magnification level, the content can be stored and indexed in a database. In this way, if the same content is requested again, it can be retrieved from the database without having to re-render the content. Moreover, since rendering information onto tiles and delivering the tiles to a user is a particularly efficient way to provide content to a user, resources are freed up and these resources can be used to provide more content to the user. For example, the user might enter a search query and, in response to the query, might receive not only search results but also suggestions of related searches, ads, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example image that may be rendered in a virtual image pyramid.

FIG. 2 is a block diagram of an example in which plural images are rendered at different zoom levels in a virtual image pyramid.

FIG. 3 is a flow diagram of an example process in which content from a virtual image pyramid may be provided to a client and displayed.

FIG. 4 is a block diagram of various actions that may be performed in connection with the techniques described herein.

FIG. 5 is a block diagram of example components that may be used in connection with implementations of the subject matter described herein.

### DETAILED DESCRIPTION

In many applications, content is delivered from a client to a server. These applications often want to be able to provide content at a variety of different zoom levels. One way to provide content at different zoom levels is to create an image pyramid. In an image pyramid, content is rendered at several different zoom levels onto tiles that have uniform spatial dimensions. When content is rendered at a low zoom level, the content takes up a smaller number of tiles. When content is rendered at a high zoom level, the content takes up a larger number of tiles. Since the tiles have a uniform size, a given tile can be transmitted from a server to a client using a constant amount of bandwidth, regardless of the zoom level of the image that is rendered onto the tile.

Rendering an image onto tiles in a pyramid provides a convenient way to manage bandwidth. For example, if a high-resolution image is to be rendered, then instead of transmitting the entire high-resolution image (which may involve transmitting a large amount of data), just enough tiles to cover the user's screen could be transmitted. If the user moves to another part of the screen, or changes the zoom level, then the appropriate additional tiles can be transmitted to cover the screen. However, image pyramids are typically pre-calculated, and thus are normally used for content that does not change, or that changes only infrequently. For content that is dynamically created or that changes frequently, images are typically delivered in other ways. For example, an image search engine might generate several thumbnail images as part of a set of search results, and might provide the images to a client one-by-one (and an overhead cost is incurred in transmitting each thumbnail separately). Or, if a high-resolution image is to be shown, the entire high-resolution image might be transmitted to a client, at a great expense of transmission bandwidth.

The subject matter described herein provides a way to use image pyramids with content that changes or that is created dynamically. When content is to be provided, the underlying content is generated. Based on what portion of the content is to be shown to a user and the zoom level at which it is to be shown (or based on some other type of state information), the appropriate portion of the content is rendered onto one or more tiles. The tile(s) are then delivered from a server to a client so that the tiles can be shown to the user. The tiles can be rendered dynamically—possibly “on demand”—thereby avoiding calculation of the entire pyramid. For example, a search application might provide images as part of search results. Based on the particular portion of the results to be shown to the user, and based on the applicable zoom level, an appropriate set of one or more tiles may be rendered. These tiles may be provided to a client to show to the user. If the zoom level changes (e.g., based on user selection, or in response to some other event), new tiles at a different zoom level can be calculated. Similarly, if the user pans around the content from one spatial region to another, then new tiles representing the new spatial region can be calculated and delivered to the client. In one example, tiles can be calculated in an anticipatory fashion: e.g., if the user is viewing a particular spatial region, then tiles adjacent to that region can be calculated in anticipation that the user will pan to those adjacent regions. The techniques described herein may be used to deliver content that could be shown at various different resolutions (e.g., photos or other images), or content whose underlying depth is infinite but that has to be rendered at a specific resolution (e.g., fractals).

Since providing content through tiles is a particularly efficient way to deliver content, it is possible to deliver additional content. For example, in an image search, the thumbnail images that form the results are typically delivered one-by-one, thereby making it expensive to provide additional thumbnails (e.g., ads, or other content that is not directly responsive to the search query). By transmitting the content efficiently through tiles, it is practical to provide these types of additional content to a user. Some examples of additional content that could be provided are ads, or metadata about the images. For example, if each image on a tile is an image of a car, then examples of some additional data that could be provided are the make manufacturer of each car, its price, its performance characteristics, interesting facts about the car, etc.

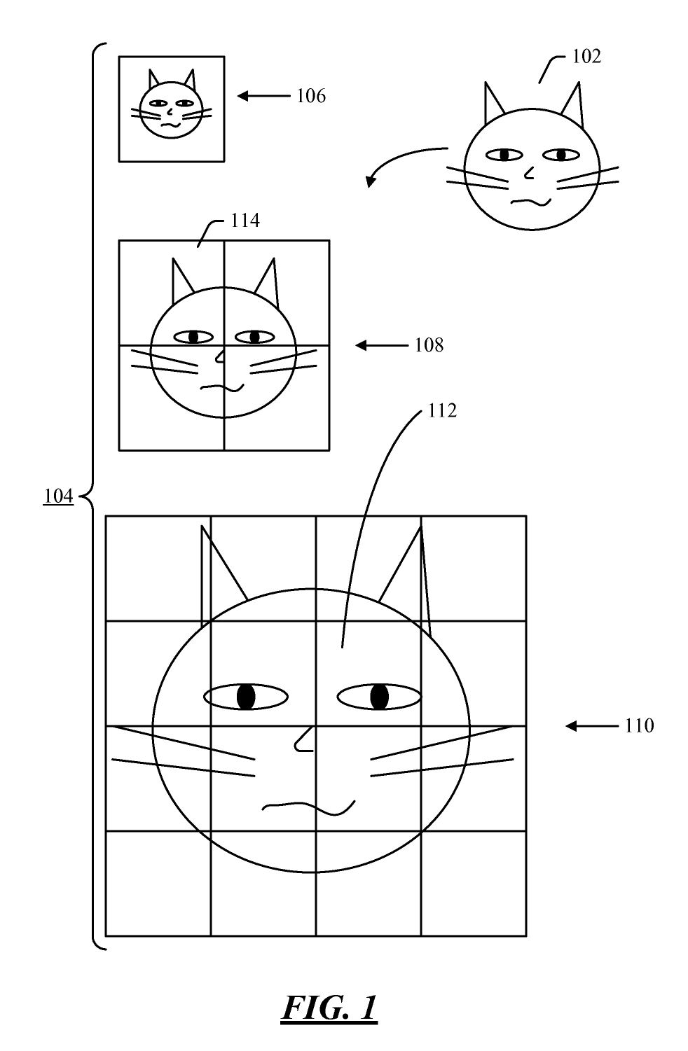

Turning now to the drawings. FIG. 1 shows an example of an image 102 that may be rendered in a virtual image pyramid. (For purposes of illustration, FIG. 1 an image of an animal as an example image, although any type of image could be used with the techniques described herein.) Image 102 could be represented in any form. For example, image 102 could be a high-resolution rasterized image. However, in another example, image 102 may be defined geometrically, thereby allowing image 102 to be rasterized at an arbitrary resolution.

Image 102 may be represented in the form of pyramid 104. Pyramid 104 contains image 102 at various zoom levels, where each zoom level corresponds to a level of the pyramid. Three zoom levels (106, 108, and 110) are shown. Pyramid 104 incorporates the concept of a tile that defines a particular spatial region. An example of a spatial region is a rectangle of a particular size and aspect ratio (e.g., a 1024×1024 rectangle), although a tile could be any shape or size. For example, tiles could be triangular, trapezoidal, etc. In the example of FIG. 1, each tile is a rectangle of a fixed size.

The number of tiles that it takes to cover the image depends on the zoom level of the image. At level 106, image 102 is rendered small, so image 102 fits in a single tile. At level 108, image 102 is rendered somewhat larger, so it takes four tiles to cover image 102. At level 110, image 102 is rendered even larger, so it takes sixteen tiles to cover image 102. Since the tiles are the same size, it will be observed that each tile has the same number of pixels regardless of zoom level. For example, if a tile corresponded to approximately one screen-full of visual content, then a screen-full of the image can be provided with an approximately constant amount of data regardless of the zoom level.

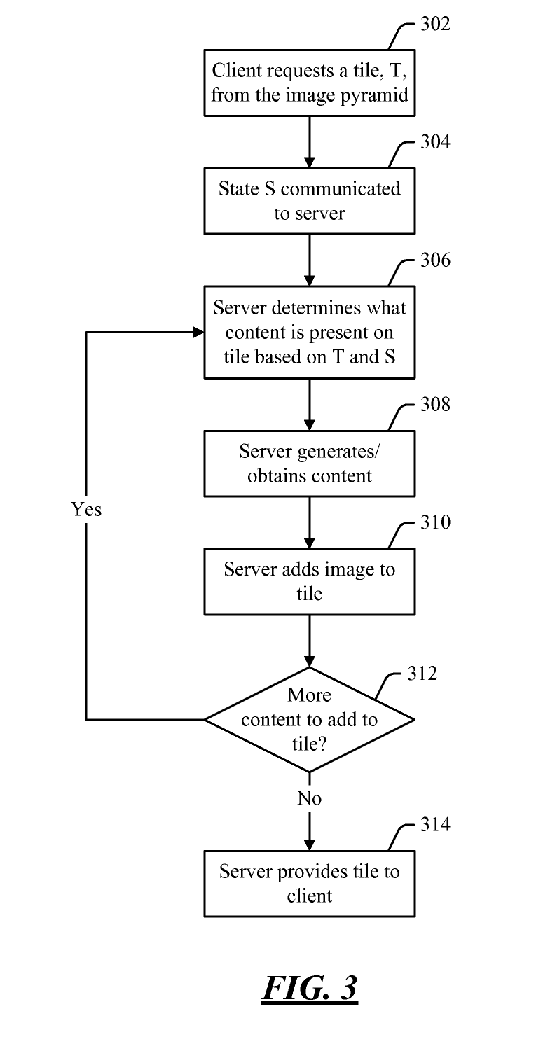

Pyramid 104 may be a virtual pyramid in the sense that it might be calculated dynamically as tiles are requested, rather than having been pre-created. For example, tile 112 represents a particular portion of image 102 at the zoom level represented by level 110. But a user might or might not request to see image 102 at the zoom level represented by level 110. Or, a user might want to see image 102 at that zoom level, but might or might not request to see the particular spatial portion that corresponds to tile 112. Thus, specific portions of image pyramid 104 might be created “on demand” (e.g., in response to a user's request to see a particular portion of the pyramid), or might be created in response to other events (or in response to no event at all). (Tile 114 is also shown in FIG. 1; it is used in an example in connection with FIG. 3, described below.)

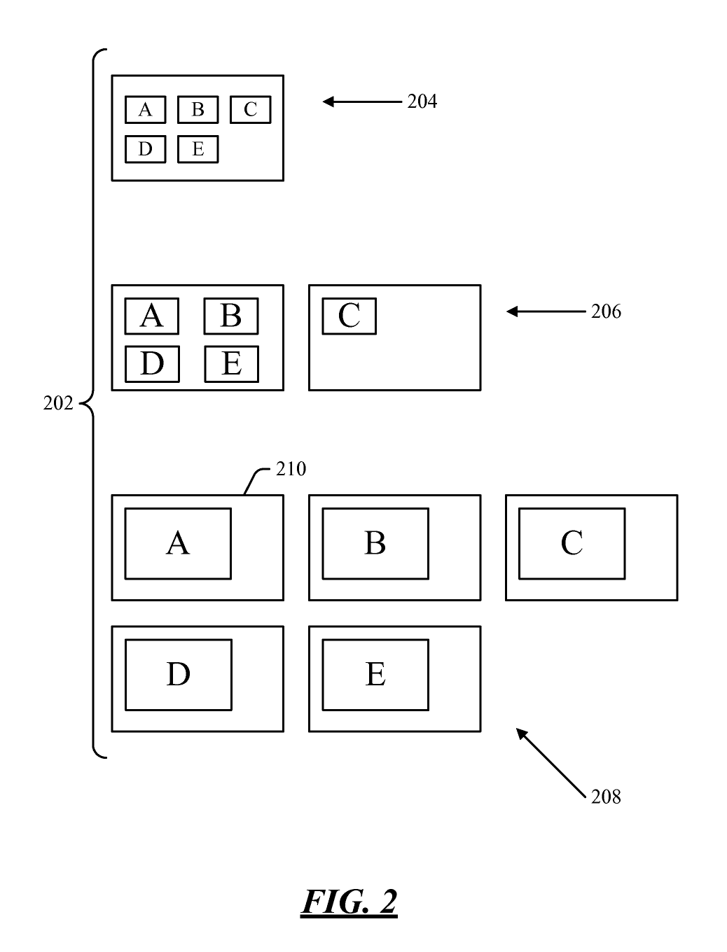

It is noted that the tiles shown in FIG. 1 (and also in FIG. 2, described below) may be described as being “distinct” from each other, in the sense that each tile covers a different spatial region and/or represents a different zoom level.

FIG. 2 shows an example in which plural images may be rendered at different zoom levels in a pyramid. An image pyramid may be used to render different zoom levels of a single image as shown in FIG. 1, but may also be used to render different zoom levels of plural images.

In FIG. 2, there are five example images, represented by the letters A, B, C, D, and E. Thus, in the example of FIG. 2, one image contains the letter A, another image contains the letter B, and so on. These several images may be arranged in a specific pattern. For example, in FIG. 2, the images are arranged in two rows, so that images A, B, and C are in the top row and images D and E are in the bottom row. For example, these images might be generated as part of an image search, where the search engine returns thumbnails of images that satisfy the search query, and shows the thumbnails three to a row. In such an example, each of the images A-E may be thought of as one of the thumbnail images.

The arrangement of images A-E into two rows may be rendered at various different zoom levels. Thus, these images may be represented in the form of a pyramid 202, having zoom levels 204, 206, and 208. At zoom level 204, images A-E all fit into a single tile. At zoom level 206, the images are larger, so they fit into two tiles, with images A, B, D, and E on one tile and image C on another tile. At zoom level 208, the images are even larger so each image takes up a separate tile.

As with pyramid 104 (shown in FIG. 1), pyramid 202 may be virtual in the sense that it is created in response to some events rather than being pre-calculated. For example, as noted above images A-E may be search results. A search engine can identify these images as being part of a set of search results without regard to how the images are to be shown to the user. Based on some type of information (e.g., user input in which a user specifies the zoom level at which he would like to see the search results), a system could determine which tile(s) of the image to generate. For example, if the user requests zoom level 208, then a system could start by generating tile 210, and could generate additional tiles from zoom level 208 as the user pans around the results.

FIG. 3 shows an example process in which content from a virtual image pyramid may be provided to a client and displayed. Before turning to a description of FIG. 3, it is noted that the flow diagram contained in FIG. 3 is described, by way of example, with reference to components shown in FIGS. 1 and 2, although this process may be carried out in any system and is not limited to the scenarios shown in FIGS. 1 and 2. Additionally, the flow diagram in FIG. 3 shows an example in which stages of a process are carried out in a particular order, as indicated by the lines connecting the blocks, but the various stages shown in this diagram can be performed in any order, or in any combination or sub-combination.

At 302, a client requests a tile from an image pyramid. The request may be received by a server. In FIG. 3, this tile is referred to as tile T. Additionally, at 304, the client may also communicate some state S to the server. To understand what it means to request tile T with state S, reference is now made to FIGS. 1 and 2. As described above in connection with FIGS. 1 and 2, a given image or set of images may be organized into one or more tiles in a pyramid. The specific way in which an image is rendered onto tiles depends on the zoom level. For example, in FIG. 1, at the lowest zoom level an entire image fits onto one tile, while at higher zoom levels the image is divided into several tiles. If a user requests to see content at a zoom level of 100% and wants to start in the upper-left-hand corner of the image, this request implies a particular tile. For example, if level 108 in FIG. 1 corresponds to a 100% zoom, then requesting to start in the upper-left-hand corner of that zoom level implies a particular tile (i.e., tile 114). This tile is the tile T referred to in FIG. 3. Additionally, the particular content to be shown on the tile may be derived from a state S. State S may contain any type of information, and the content to be provided to the user may be generated and/or chosen based on state S. For example, if a user is interacting with a search application, state S may include a query. Thus, the particular content to be provided to the user (i.e., the search results) is dependent on state S in the sense that the search results depend on the query. State S, however, may include other information. For example, the user might sign in under a profile, which specifies information such as the user's choice of color scheme (which can be incorporated into the tiles), interests that the user has expressed, or other information, and content may be provided based on this information. E.g., if the user has expressed interest in some topics, the content that is generated for the user might include ads based on those topics, or suggestions for additional searches. As another example, state S might include an indication of a particular zoom level at which the user would like to see content displayed.

It is noted that the specification of tile T and state S may overlap somewhat. For example, a user's profile might include information such as the user's chosen default zoom level. This profile information might be part of the state S, in which case the particular tile to be shown to the user may be determined, at least in part, based on state S.

Returning now to FIG. 3, at 306 the server determines what content items (e.g., images or other types of content) are present on the tile that has been requested. This determination may be made, for example, based on the particular tile T that has been specified, and/or based on state S. (It is noted that the determination of what content is to appear on the tile is typically made subsequent to the request, in the sense that the creation of tiles may be reactive to user input rather than using tiles from a pre-calculated pyramid.) In the example where the user is performing an image search, state S (which, as noted above, might include a query) determines which images will be returned as search results. Therefore, the content of a tile to be shown to a user can be determined based on the particular set of search results to be returned, the zoom level at which the content is to be shown to the user, and the spatial location within that zoom level (e.g., upper-right-hand corner) at which the content is to be shown. Once this content has been determined, the server generates and/or obtains the content to be included on the tile (at 308). For example, images that are defined geometrically may be rendered (which is an example of generating content), or existing images may be retrieved from a database (which is an example of obtaining content).

At 310, the server adds the image data to the tile. At 312, the server determines whether there is additional content to add to the tile. If so, then the process returns to 306 to identify what the additional content is, and to obtain and/or generate this content. If there is no additional content to add to the tile, then the process continues to 314 and provides the generated tile to the client.

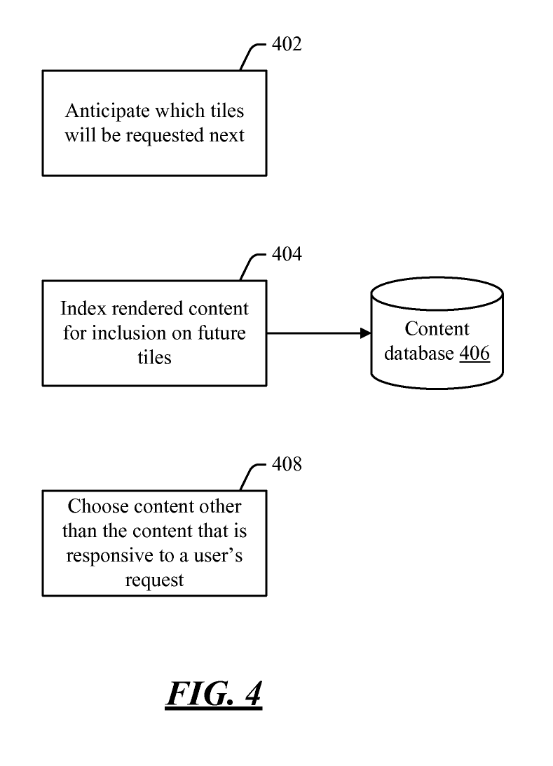

The above-described techniques may be used with a number of variations. Some of these variations are shown in FIG. 4 and are described below.

One example variation is to prepare tiles in anticipation of requests for those tiles (block 402). For example, suppose that a search application generates content in response to a search query. The application might only be able to show one screen-full of the content at a time, but if a user is looking at a particular screen-full of content, is it is reasonable to guess that the user may soon look at content that is adjacent to that screen-full. Thus, the tiles that correspond to regions adjacent to the one being viewed can be pre-rendered, so that those tiles will be ready when requested. Rendering tiles adjacent to the one being viewed is one example of how the preparation of tiles can be anticipated, although any tile could be prepared in anticipation of the tile's being requested.

Another example variation of the techniques described above is to store and index images, so that they may be included in future tiles (at 404). For example, suppose that a search engine returns a set of images that is responsive to a query. The images may be rendered onto tiles, so that the tiles may be shown to the user as search results. However, the same images might be responsive to future searches. Thus, instead of re-rendering the images in response to a future search, the images may be stored in a content database 406 and indexed in some manner. In that way, the computational effort that has been expended to render the images can be re-used, and the already-rendered images can be found in the database to include in future tiles.

An additional variation on the techniques described above is to include content other than that which is responsive to a user request (block 408). As noted above, in one example an application that provides content in the form of tiles is a search engine. The search results are directly responsive to a user's request. However, it is possible to provide content other than that which is directly responsive to the user's request. For example, some of the content on a tile might include advertisements, suggested searches, etc. It is noted that providing content on tiles is a particularly efficient way to deliver content to a user, since doing so can deliver a screen-full of information to the user in a single communication. One way to use this efficiency is to provide more content to the user than would otherwise have been provided. Advertisements, suggested searches, etc., are some examples of this additional content. (It is noted that, in general, the content that is provided on tile can be said to “follow” a request, even if that content is not said to respond to the request. Thus, content that “responds” to a request is a specific, non-limiting example of content that “follows” a request.)

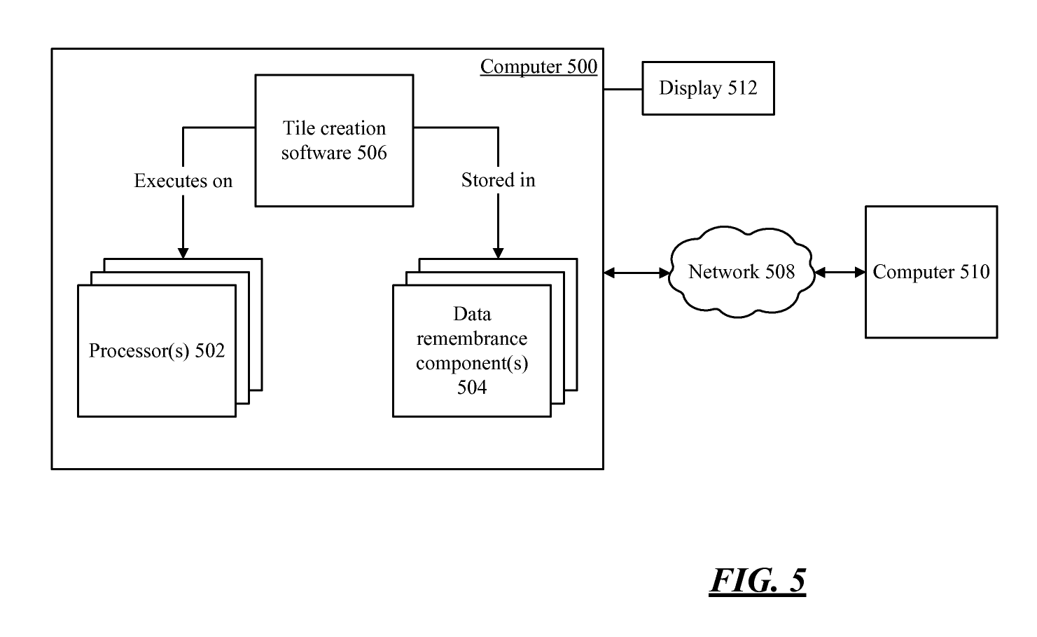

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is tile creation software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more non-transitory computer-readable media that store executable instructions to perform a method of providing content, wherein the executable instructions, when executed by a computer, cause the computer to perform acts comprising:
receiving a first request from a client;
identifying one or more content items to be provided following said first request;
subsequent to receiving said first request, generating a first tile of a pyramid based on said one or more content items, said first tile containing at least one of said content items at a zoom level; and
providing said first tile to said client.

2. The one or more non-transitory computer-readable media of claim 1, wherein said one or more content items are responsive to said first request.

3. The one or more non-transitory computer-readable media of claim 1, wherein said acts further comprise:
generating a plurality of tiles of said pyramid based on said one or more content items; and
providing said plurality of tiles to said client;
wherein said plurality of tiles comprises said first tile.

4. The one or more non-transitory computer-readable media of claim 1, wherein said acts further comprise:
receiving an indication of said zoom level from said client.

5. The one or more non-transitory computer-readable media of claim 1, wherein said one or more content items comprise one or more images, wherein said generating comprises rendering image content from said one or more images onto said first tile.

6. The one or more non-transitory computer-readable media of claim 5, wherein said first request comprises a search query, and wherein said identifying of said one or more content items comprises:
generating results of a search based on said search query, wherein said results comprise said one or more images.

7. The one or more non-transitory computer-readable media of claim 1, wherein said acts further comprise:
storing and indexing said one or more content items in a database.

8. The one or more non-transitory computer-readable media of claim 7, wherein said acts further comprise:
retrieving one of said content items from said database; and
including the retrieved content items on a second tile that is distinct from said first tile.

9. The one or more non-transitory computer-readable media of claim 1, wherein said first request identifies said first tile, and wherein said acts further comprise:
in anticipation of a second request for a second tile that is distinct from said first tile and that has not been requested, generating said second tile.

10. A method of providing content, the method comprising:
using a processor to perform acts comprising:
receiving a request from a client;
identifying one or more images to be provided following the request;
subsequent to receiving said request, generating a first tile of a pyramid based on said one or more images, said first tile containing at least one of said images, or a portion of at least one of said images; and
providing said first tile to said client.

11. The method of claim 10, wherein said one or more images are responsive to said request.

12. The method of claim 10, wherein said acts further comprise:
generating a plurality of tiles of said pyramid based on said one or more images; and
providing said plurality of tiles to said client;
wherein said plurality of tiles comprises said first tile.

13. The method of claim 10, wherein said acts further comprise:
receiving an indication of a zoom level from said client, wherein said first tile is at said zoom level in said pyramid.

14. The method of claim 10, wherein said request comprises a search query, and wherein said identifying of said one or more images comprises:
generating results of a search based on said query, wherein said results comprise said one or more images.

15. The method of claim 10, wherein said acts further comprise:
storing and indexing said one or more images in a database.

16. The method of claim 15, wherein said acts further comprise:
retrieving one of said images from said database; and
including the retrieved images on a second tile that is distinct from said first tile.

17. The method of claim 10, wherein said request identifies said first tile, and wherein said acts further comprise:
in anticipation of a request for a second tile that is distinct from said first tile and that has not been requested, generating said second tile.

18. A system for providing content, the system comprising:
a memory;
a processor;
a tile creation component that is stored in said memory and that executes on said processor, wherein said tile creation component receives first information from a client, said first information comprising state information and identifying a first spatial region to be displayed by said client, wherein said tile creation component identifies one or more content items to be provided in response to said first information, and wherein said tile creation component generates, subsequent to receiving said first information, a first tile of a pyramid that comprises one of said one or more content items or a portion thereof and that either comprises or is part of said first spatial region, and wherein said tile creation component provides said first tile to said client.

19. The system of claim 18, wherein said first information comprises a search query, and wherein said tile creation component identifies said one or more content items by generating results of a search based on said search query, wherein said results comprise said one or more content items.

20. The system of claim 18, wherein said tile creation component generates, in anticipation of a request to display a second spatial region that is distinct from said first spatial region, a second tile that comprises or is part of said second spatial region.
